(19) United States
(12) Patent Application Publication
(10) Pub. No.: US 2020/0135127 A1
(43) Pub. Date: Apr. 30, 2020

(54) DISPLAY APPARATUS OF MULTI DISPLAY SYSTEM AND CONTROL METHOD THEREOF

(71) Applicant: SAMSUNG ELECTRONICS CO., LTD., Suwon-si (KR)

(72) Inventors: Hyeyoung Jung, Suwon-si (KR); Sungju Lee, Suwon-si (KR); Juyong Kim, Suwon-si (KR); Jinsung An, Suwon-si (KR); Seungsin Lee, Suwon-si (KR); Seoyoung Jung, Suwon-si (KR)

(73) Assignee: SAMSUNG ELECTRONICS CO., LTD., Suwon-si (KR)

(21) Appl. No.: 16/660,991

(22) Filed: Oct. 23, 2019

(30) Foreign Application Priority Data
Oct. 25, 2018 (KR) 10-2018-0128001

(51) Int. Cl. G09G 3/36; G09G 3/3225; G09G 5/10

(52) U.S. Cl. CPC G09G 3/3648; G09G 3/3225; G09G 2360/144; G09G 2320/0673; G09G 2320/0626; G09G 5/10

(57) ABSTRACT

A first display apparatus includes a display; a communicator configured to communicate with a second display apparatus; and a processor configured to: display an image on the display, obtain a first ambient light value of a first ambient light of the first display apparatus, receive a second ambient light value of a second ambient light of the second display apparatus and a second image-quality value of the second display apparatus through the communicator, and adjust a first image-quality value of the displayed image based on the second image-quality value and the first ambient light value, by using a relationship between the second ambient light value of the second ambient light and the second image-quality value of the second display apparatus.

### CROSS-REFERENCE TO THE RELATED APPLICATION

This application claims priority from Korean Patent Application No. 10-2018-0128001, filed on Oct. 25, 2018 in the Korean Intellectual Property Office, the disclosure of which is incorporated by reference herein in its entirety.

### BACKGROUND

### Field

Example embodiments of the disclosure relate to a multi display system with display apparatuses, which process an image signal to be displayed thereon or output to an outside, and a method of controlling the same, and more particularly to a multi display system with display apparatuses, in which a plurality of displays installed in different environments enables a user watching a certain display to adjust image quality of an image displayed on another display, and a method of controlling the same.

### Description of the Related Art

To compute and process predetermined information in accordance with certain processes, an electronic apparatus basically includes a central processing unit (CPU), a chipset, a memory, and the like electronic components for the computation. Such an electronic apparatus may be variously classified in accordance with what information will be processed and for what purpose the processed information will be used. For example, the electronic apparatus is classified into an information processing apparatus such as a personal computer (PC), a server or the like for processing general information; an image processing apparatus for processing image data; an audio apparatus for audio process; home appliances for miscellaneous household chores; etc. The image processing apparatus may be provided by a display apparatus that displays processed image data as an image on its own display panel. Examples of the image processing apparatus provided by a single display apparatus include a television (TV), a monitor, a portable multimedia player, a tablet computer, a mobile phone, etc. An example of the image processing apparatus provided by a plurality of display apparatuses includes a video wall.

When a plurality of displays or display apparatuses are provided, the plurality of displays or display apparatuses may be installed in different display environments. For example, there is a double-sided display system, in which two displays are arranged on opposite sides of a building window or the like, with a first display on an indoor side and a second display on an outdoor side. In this case, even if the first display on the indoor side and the second display on the outdoor side display images with the same image quality, the image qualities of the images are perceived differently by a human because display environments of the first display and the second display are different.

Under such environments, it will be assumed that a user of the first display wants to adjust the image quality of the image displayed on the second display. In this case, the second display transmits data of an image to the first display, and the first display processes the received data and displays the image. The first display transmits a setting value for image quality, which is input by a user with respect to the displayed image on the first display, to the second display. The second display adjusts the image quality of the image based on the received setting value.

Here, the first display and the second display are different in the display environment, and therefore, the image finally displayed on the second display may not be recognized as having the image quality intended by a user. For example, under an environment that the outside of the building has greater difference in an illumination level than the inside of the building, even if an image is adjusted by a user to be recognized by a human as having a certain image quality when displayed on the first display on the indoor side, it may be difficult for a human to recognize the image as having the certain image quality when displayed on the second display on the outdoor side.

Moreover, it is inconvenient for a user to personally check the image displayed on the second display after the adjustment to ensure if the adjusted image has the intended image quality. Also, the personal checking of the image after the adjustment by the user may not be accurate in determining if the adjusted image has the intended image quality. Therefore, when a user uses the first display to adjust the image quality of the image displayed on the second display, there is a need for technology to enable the user to easily determine how an image displayed on the second display will be recognized after adjustment.

### SUMMARY

According to an aspect of an example embodiment of the disclosure, there is provided a display apparatus, including: a display; a communicator configured to communicate with a second display apparatus; and a processor configured to: display an image on the display, obtain a first ambient light value of a first ambient light of the first display apparatus, receive a second ambient light value of a second ambient light of the second display apparatus and a second image-quality value of the second display apparatus through the communicator, and adjust a first image-quality value of the displayed image based on the second image-quality value and the first ambient light value, by using a relationship between the second ambient light value of the second ambient light and the second image-quality value of the second display apparatus.

The first ambient light value and/or the second ambient light value may include at least one of an illumination value or a color temperature value of the first ambient light and/or the second ambient light.

The processor may be further configured to adjust the first image-quality value by changing at least one of brightness or a gamma curve of the displayed image.

The processor may be further configured to adjust the first image-quality value with reference to a table in which a plurality of preset image-quality values are tabulated corresponding to a plurality of ambient light values.

The processor may be further configured to adjust the first image-quality value by using a preset function or a preset algorithm based on a relationship between an ambient light value and an image-quality value.

The processor may be further configured to receive a user input value for the first ambient light from the second display apparatus, through the communicator.

The processor may be further configured to: display a user interface (UI) including a plurality of selectable menu items about information of the first ambient light, and receive, through the user interface, a user input value among the plurality of selectable menu items, and determine the first ambient light value of the first ambient light based on the user input value.

The processor may be further configured to receive the first ambient light value of the first ambient light from a server through the communicator.

The processor may be further configured to selectively perform adjustment of the first image-quality value based on whether a difference between the first ambient light value of the first ambient light and the received second ambient light value of the second ambient light is greater than a threshold apparatus.

The processor may be further configured to selectively perform adjustment of the first image-quality value based on whether a current time is in a preset timeslot.

The first display apparatus may further include a user input interface, wherein the processor may be further configured to: adjust a third image-quality value of a second image displayed on the display based on a user input received through the user input interface, and transmit, to the second display apparatus through the communicator, the adjusted third image-quality value of the second image and a third ambient light value of the first ambient light of the first display apparatus detected while displaying the second image.

The first display apparatus may further include a sensor configured to detect the second ambient light value of the second ambient light of the first display apparatus.

According to an aspect of an example embodiment of the disclosure, there is provided a display system, including: a first display apparatus; and a second display apparatus placed in a different display environment from that of the first display apparatus, the first display apparatus including: a first display; a first communicator configured to communicate with the second display apparatus; a first sensor configured to detect a first ambient light of the first display apparatus; a first user input interface; and a first processor configured to: display a first image on the first display, adjust a first image-quality value of the displayed first image based on a user input received through the first user input interface, and transmit the adjusted first image-quality value and a first ambient light value of the detected first ambient light to the second display apparatus through the first communicator, and the second display apparatus including: a second display; a second communicator configured to communicate with the first display apparatus; a second sensor configured to detect a second ambient light of the second display apparatus; and a second processor configured to: receive the adjusted first image-quality value and the first ambient light value of the first display apparatus through the second communicator, and adjust a second image-quality value of a second image displayed on the second display based on the first image-quality value and a second ambient light value of the second ambient light of the second display apparatus, by using a relationship between the first ambient light value of the first ambient light and the first image-quality value of the first display apparatus.

The first ambient light value and/or the second ambient light value may include at least one of an illumination value or a color temperature value of the first ambient light and/or the second ambient light.

The first processor and/or the second processor may be further configured to adjust the first image-quality value and/or the second image-quality value by changing at least one of brightness or a gamma curve of the first image or the second image.

The first processor and/or the second processor may be further configured to adjust the first image-quality value and/or the second image-quality value with reference to a table in which a plurality of preset image-quality values are tabulated corresponding to a plurality of ambient light values.

The first processor and/or the second processor may be further configured to adjust the first image-quality value and/or the second image-quality value by using a preset function or a preset algorithm based on a relationship between an ambient light value and an image-quality value.

According to an aspect of an example embodiment of the disclosure, there is provided a method of controlling a first display apparatus, the method including: displaying an image on the first display apparatus; obtaining a first ambient light value of a first ambient light of the first display apparatus; receiving a second ambient light value of a second ambient light of a second display apparatus, and a second image-quality value of the second display apparatus; and adjusting a first image-quality value of the image displayed on the first display apparatus based on the second image-quality value and the first ambient light value of the first ambient light of the first display apparatus, by using a relationship between the second ambient light value of the second ambient light and the second image-quality value of the second display apparatus.

According to an aspect of an example embodiment of the disclosure, there is provided a display apparatus including: a display; a user input unit; a communicator configured to communicate with an external display apparatus; a sensor unit configured to detect ambient light of the display apparatus; and a processor configured to: receive an ambient light value of the external display apparatus through the communicator, control the display to display an image of which an image-quality value is adjusted corresponding to an ambient light value of ambient light detected based on a corresponding relationship between the ambient light value and the image-quality value of the external display apparatus, adjust the image-quality value of the displayed image based on a user's input received through the user input unit, and transmit the adjusted image-quality value and the detected ambient light value to the external display apparatus through the communicator.

The processor may transmit a second ambient light value of ambient light, which is detected when the second image is displayed, to the external display apparatus through the communicator, receive second image-quality value of the external display apparatus adjusted based on the second ambient light value through the communicator, and adjust the displayed second image with the second image-quality value.

A method of controlling a display apparatus, including: displaying an image on the display apparatus; receiving an ambient light value of an external display apparatus, and an image-quality value of the external display apparatus; obtaining an ambient light value by detecting ambient light of the display apparatus; and adjusting an image-quality value of an image displayed on the display apparatus to correspond to the obtained ambient light value based on a corresponding relationship between the ambient light value and the image-quality value of the external display apparatus.

According to an example embodiment of the disclosure of the disclosure, there is provided a method of controlling a display system including a first display apparatus and a second display apparatus, the method including: displaying an image on a first display apparatus; adjusting an image-quality value of the image displayed on the first display apparatus based on a user's input; obtaining an ambient light value by detecting ambient light of the first display apparatus; obtaining an ambient light value by detecting ambient light of the second display apparatus; and adjusting the image-quality value of the image displayed on the second display apparatus to correspond to the ambient light value of the second display apparatus based on a corresponding relationship between the ambient light value of the first display apparatus and the adjusted image-quality value.

According to an example embodiment of the disclosure of the disclosure, there is provided a display apparatus including: a first display, a communicator, and a processor configured to: obtain an illumination value of the second display, and a first image-quality value, of which image quality of an image displayed on the second display is adjusted based on a user's input, through the communicator; identify a second image-quality value corresponding to an illumination value of the second display based on a corresponding relationship between the illumination value of the second display and the first image-quality value; and display the image with the identified second image-quality value on the first display.

According to an example embodiment of the disclosure of the disclosure, there is provided a display apparatus including: a first display, a second display, a user input unit, and a processor configured to identify a first image-quality value corresponding to an illumination value of the first display based on a corresponding relationship between the illumination value of the second display and the image-quality value of the image, display the image having the identified first image-quality value on the first display, obtain a second image-quality value by adjusting the image quality of the image displayed on the first display based on a user's input received through the user input unit, and display the image having the obtained second image-quality value on the second display.

According to an example embodiment of the disclosure of the disclosure, there is provided a display apparatus including: a first display, a user input unit, a communicator, and a processor configured to: obtain an illumination value of the second display through the communicator, identify a first image-quality value corresponding to an illumination value of the first display based on a corresponding relationship between the illumination value of the second display and the image-quality value of the image, display an image having the identified first image-quality value on the first display, obtain a second image-quality value by adjusting the image displayed on the first display based on a user's input received through the user input unit, and transmit the obtained second image-quality value through the communicator to adjust the image quality of the image to be displayed on the second display.

According to an example embodiment of the disclosure of the disclosure, there is provided a method of controlling a display apparatus including a first display and a second display, the method including: displaying an image on the first display; obtaining a first image-quality value by adjusting image quality of the image displayed on the first display based on a user's input; identifying a second image-quality value corresponding to an illumination value of the second display based on a corresponding relationship between the illumination value of the first display and the first image-quality value; and displaying the image having the identified second image-quality value on the second display.

### BRIEF DESCRIPTION OF THE DRAWINGS

The above and/or other aspects will become apparent and more readily appreciated from the following description of example embodiments, taken in conjunction with the accompanying drawings, in which:

FIG. 1 illustrates a system according to an example embodiment of the disclosure;

FIG. 2 is a block diagram of a display apparatus according to an example embodiment of the disclosure;

FIG. 3 is a flowchart of controlling a system according to an example embodiment of the disclosure;

FIG. 4 illustrates operations of a first display apparatus to estimate image quality recognized with respect to an image displayed on a second display apparatus in a system according to an example embodiment of the disclosure;

FIG. 5 illustrates a principle of adjusting an illumination level of an image based on difference in an illumination level between display environments in a system according to an example embodiment of the disclosure;

FIG. 6 illustrates a principle of adjusting an RGB level of an image based on difference in color temperature between display environments in a system according to an example embodiment of the disclosure;

FIG. 7 illustrates a principle that a display apparatus according to an example embodiment of the disclosure identifies ambient light among conditions of display environments based on a user's input;

FIG. 8 illustrates a principle that the display apparatus according to an example embodiment of the disclosure identifies an ambient color temperature among conditions of display environments based on a user's input;

FIG. 9 illustrates operations of a second display apparatus to estimate image quality recognized with respect to an image displayed on a first display apparatus in a system according to an example embodiment of the disclosure;

FIG. 10 is a block diagram of an image processing apparatus controlling a plurality of display apparatuses in a system of the disclosure;

FIG. 11 illustrates operations of an image processing apparatus to estimate image quality recognized with respect to an image displayed on a first display apparatus in a system according to an example embodiment of the disclosure;

FIG. 12 is a flowchart of selectively performing an image-quality simulating process based on difference in an illumination level by a first display apparatus according to an example embodiment of the disclosure;

FIG. 13 is a flowchart of selectively performing an image-quality simulating process based on a timeslot by a first display apparatus according to an example embodiment of the disclosure;

FIG. 14 is a block diagram of a display apparatus according to an example embodiment of the disclosure; and

FIG. 15 illustrates operations of a display apparatus according to an example embodiment of the disclosure to estimate image quality recognized with respect to an image displayed on a first display unit.

### DETAILED DESCRIPTION

Below, example embodiments will be described in detail with reference to accompanying drawings. Further, the example embodiments described with reference to the accompanying drawings are not exclusive to each other unless otherwise mentioned, and a plurality of embodiments may be selectively combined within one apparatus. The combination of the plurality of embodiments may be discretionally selected and applied to realize the disclosure by a person having an ordinary skill in the art.

In the description of the example embodiments, an ordinal number used in terms such as a first element, a second element, etc. is employed for describing variety of elements, and the terms are used for distinguishing between one element and another element. Therefore, the meanings of the elements are not limited by the terms, and the terms are also used just for explaining the corresponding embodiment without limiting the disclosure.

In the disclosure, the term “at least one of” includes any and all combinations of one or more of the associated listed items. Further, a term “at least one” among a plurality of elements in the disclosure represents not only all the elements but also each one of the elements, which excludes the other elements or all combinations of the elements. For example, the term “at least one of A and B” or “at least one of A or B” is used to describe that three cases may exist: only A exists, both A and B exist, and only B exists. Similarly, “at least one of A, B, and C” or “at least one of A, B, or C” indicates that there may exist seven cases: only A exists, only B exists, only C exists, both A and B exist, both A and C exist, both C and B exist, and all A, B, and C exist.

In the following description, a term ‘module,’ unit,' or ‘part’ refers to an element that performs at least one function or operation. The ‘module’ or ‘unit’ may be realized as hardware, software, or combinations thereof. A plurality of ‘modules,’ ‘units,’ or ‘parts’ may be integrated into at least one module or chip and realized as at least one processor, except for a case where respective ‘modules’ or ‘units’ need to be realized as discrete specific hardware.

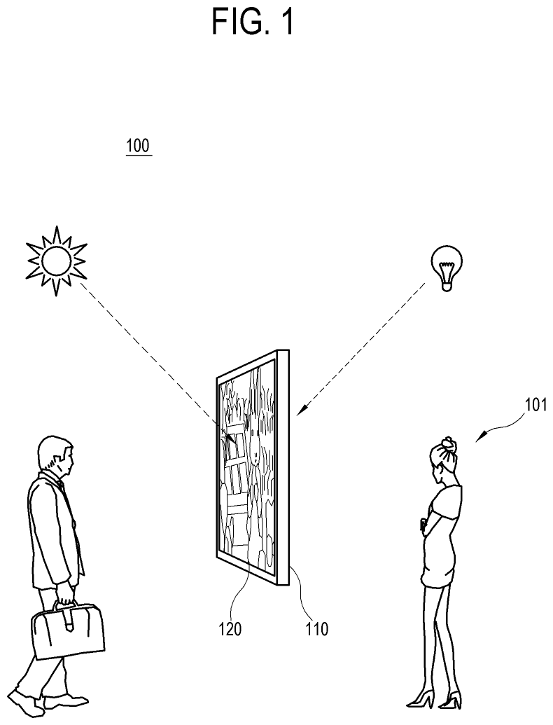

FIG. 1 illustrates a system according to an example embodiment of the disclosure.

As shown in FIG. 1, a display system 100 (hereinafter, also referred to as a ‘system’) according to an example embodiment of the disclosure includes a plurality of displays 110 and 120, each of which can operate individually. The plurality of displays 110 and 120 includes a first display 110 and a second display 120, screens of which are arranged on opposite sides to have a double-sided display structure. The first display 110 and the second display 120 may have a structure to be physically separated and spaced apart from each other, as well as the double-sided display structure. The first display 110 and the second display 120 are provided as separate apparatuses to respectively process and display an image signal, and may be respectively called a first display apparatus 110 and a second display apparatus 120. When the first display apparatus 110 and the second display apparatus 120 according to an example embodiment of the disclosure indicate two display apparatuses of two or more individual display apparatuses included in the system 100, they may be variously called ‘a master display apparatus/a slave display apparatus’, ‘an internal display apparatus/an external display apparatus’, etc. hereinafter in an example embodiment of the disclosure. For example, when an image quality of the second display apparatus 120 is adjusted by the user through the first display apparatus 110, the first display apparatus 110 may be called a master display apparatus and the second display apparatus 120 may be called a slave or an external display apparatus. On the other hand, when an image quality of the first display apparatus 110 is adjusted by the user through the second display apparatus 120, the second display apparatus 120 may be called a master display apparatus and the first display apparatus 110 may be called a slave or an external display apparatus.

The first display apparatus 110 and the second display apparatus 120 may communicate with each other through wired or wireless connection. When a display environment of the first display apparatus 110 is called a first display environment and a display environment of the second display apparatus 120 is called a second display environment, the first display environment and the second display environment are different from each other. The display environment of the display apparatus according to an example embodiment of the disclosure refers to a condition that influences a color tone of an image to be recognized by a user who is viewing the image displayed on the display apparatus. A difference in the display environment between the first display apparatus 110 and the second display apparatus 120 means that a color tone recognized by a user viewing an image in the first display environment of the first display apparatus 110 is different from a color tone recognized by a user viewing the same image in the second display environment of the second display apparatus 120. For example, the first display environment in an example embodiment may refer to a condition of indoor room light, and the second display environment may refer to a condition of outdoor sunlight. In more detail, the display environment according to an example embodiment of the disclosure may be specified by characteristics of light around the display apparatus, for example, an illumination value, a color temperature, etc. or other characteristics around the display apparatus such as ambient temperature, humidity, etc. Alternatively, the first display environment may refer to a condition that the first display apparatus 110 is tilted frontward, but the second display environment may refer to a condition that the second display apparatus 120 stands vertically. The first display environment and the second display environment are only terms to distinguish between different display environments, and each display environment is not construed as being limited to the foregoing examples.

Under such environments, it will be assumed, for example, that a user 101 in a room wants to control the characteristics of the image displayed on the second display apparatus 120. According to an example embodiment of the disclosure, the characteristics of the image include values representing a quality of the image (hereinafter, referred to as an ‘image quality value’ or a ‘setting value’ according to descriptions) of an image, such as the brightness, color, contrast, etc. of an image. The first display apparatus 110 obtains data of an image displayed on the second display apparatus 120, and processes the obtained data to display an image. Based on the image displayed on the first display apparatus 110, the user 101 may input or adjust a setting value about various attributes of the image through a user input interface provided in the first display apparatus 110. The first display apparatus 110 transmits information about the setting value input by a user to the second display apparatus 120. The second display apparatus 120 displays the image based on the setting value received from the first display apparatus 110.

However, the first display environment and the second display environment are different in a condition related to the ambient light from each other. For example, the ambient brightness of the second display environment under influence of sunlight is much higher than that of the first display environment light under influence of electric light. On the other hand, at night, the ambient brightness of the second display environment may be lower than that of the first display environment. The conditions related to the ambient light may be influenced by various parameters such as the color temperature of the ambient light, etc. as well as the ambient brightness. Even if the brightness of the ambient light is equally given, the first display environment and the second display environment may be different because of difference in the ambient temperature, humidity or the like, whether the apparatus is tiled frontward, etc.

Due to such difference between the display environments, image quality or color tone of an image (hereinafter, the term ‘image quality’ should be construed as involving the ‘color tone’) recognized by a human who views the image in a certain display environment may be different from the image quality of the image recognized in another display environment. Further, even if the same image is displayed, the image displayed on the first display apparatus 110 and the image displayed on the second display apparatus 120 may be recognized with different color tones by a human. This means that the image, of which the image quality is adjusted through the first display apparatus 100 as recognized by the user 101, may not be recognized with the image quality as intended by the user 101 when the adjusted image is displayed on the second display apparatus 120.

To solve the above problem, when the user 101 under the first display environment adjusts the image quality of the image displayed on the first display apparatus 110 and causes the adjusted image to be displayed on the second display apparatus 120, the system 100 according to an example embodiment operates as follows.

When data of an image displayed on the second display apparatus 120 is to be displayed on the first display apparatus 110, the system 100 simulates the image with the image quality by taking the influences of both the first display environment and the second display environment into account. Thus, the system 100 controls the image to be displayed on the first display apparatus 110 under the first display environment with the same color tone as that a user recognizes in the second display environment, thereby allowing the user in the first display environment to adjust the image based on the image actually displayed under the second display environment. Details of operations of the system 100 will be described later.

Below, the configurations of the first display apparatus 110 and the second display apparatus 120 will be described.

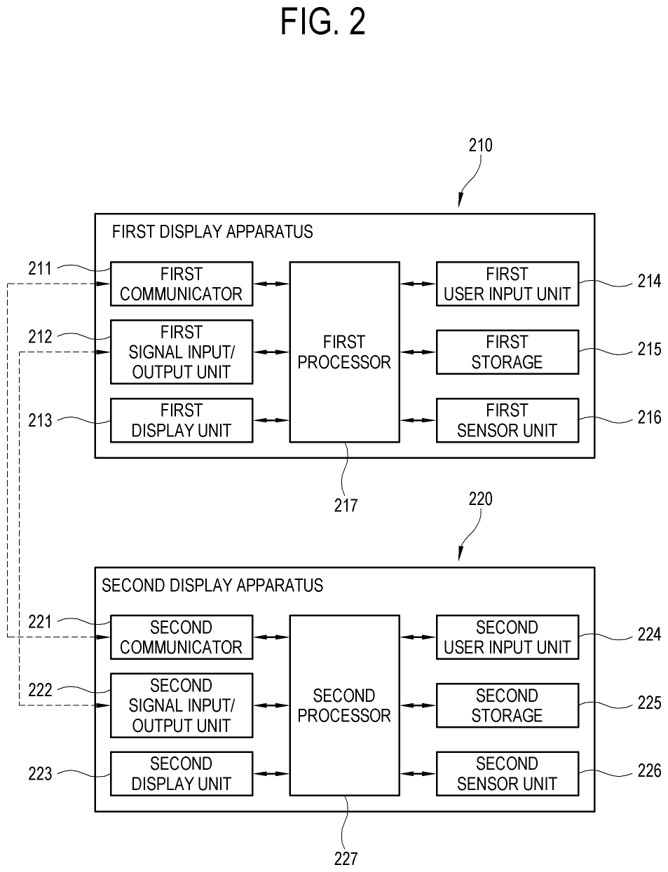

FIG. 2 is a block diagram of a display apparatus according to an example embodiment of the disclosure.

As shown in FIG. 2, a first display apparatus 210 and a second display apparatus 220 are provided. In FIG. 2, the first display apparatus 210 and the second display apparatus 220 may be substantially the same as those shown in FIG. 1.

The first display apparatus 210 includes a first communicator 211 configured to communicate with the second display apparatus 220, a first signal input/output unit 212 (or first signal input/output interface) configured to input/output a predetermined signal or data, a first display unit 213 (or a first display) configured to display an image, a first user input unit 214 (or a first user input interface) configured to receive a user's input, a first storage 215 configured to store data, a first sensor unit 216 (or a first sensor) configured to detect a condition of a display environment of the first display apparatus 210, and a first processor 217 configured to process data. It should be noted that the configuration of the first display apparatus 210 is not limited to the foregoing elements, but may additionally include other elements as needed or may be subjected to modification with respect to the foregoing elements.

Below, each element of the first display apparatus 210 will be described.

The first communicator 211 refers to an interactive communication circuit that includes at least one of elements, such as communication modules, communication chips, etc. corresponding to various wired and wireless communication protocols. For example, the first communicator 211 may be provided by a wireless communication module configured to perform wireless communication with an access point (AP) through Wi-Fi, or a local area network (LAN) connected to a router or a gateway by a wire.

The first signal input/output unit 212 is one-to-one or one-to-many connected to a predetermined external apparatus such as the second display apparatus 220, thereby receiving or outputting data with regard to the corresponding external apparatus. The first signal input/output unit 212 includes a plurality of connectors or a plurality of ports, which for example complies with high definition multimedia interface (HDMI), DisplayPort (DP), and the like standards.

The first display unit 213 includes a display panel capable of displaying an image on a screen. The display panel is provided to have a light receiving structure such as a liquid crystal type, or a self-emissive structure such as an organic light emitting diode (OLED) type. The first display unit 213 may include an additional element according to the structures of the display panel. For example, when the display panel is the liquid crystal type, the display 330 includes a liquid crystal display panel, a backlight unit configured to emit light, a panel driving substrate configured to drive liquid crystal of the liquid crystal display panel, etc.

The first user input unit 214 includes various input interfaces through which a user can make an input. The first user input unit 214 may be variously configured according to the types of the first display apparatus 210, and may for example include mechanical or electronic buttons of the first display apparatus 210, a remote controller separated from the display apparatus 210, a touch pad, a touch screen provided on the first display unit 213, etc.

The first storage 215 is accessed by the first processor 217, and performs operations such as reading, recording, modifying, deleting, updating, etc. for data under control of the first processor 217. The first storage 215 includes a flash memory, a hard disk drive (HDD), a solid state drive (SSD), and the like nonvolatile memory in which data is retained regardless of whether power is supplied or not; and a buffer, a random access memory (RAM) and the like volatile memory to which processing data is loaded.

The first sensor unit 216 includes one or more sensors configured to detect one or more conditions among conditions of various attributes of the first display environment in which the first display apparatus 210 is installed. The first sensor unit 216 may for example include one or more among various sensors such as an illumination sensor configured to detect brightness of the first display environment, a color sensor configured to detect a color temperature of light in the first display environment, a temperature/humidity sensor configured to detect temperature or humidity of the first display environment, a sensor configured to detect an installation angle, a display angle, etc. of the first display apparatus 210.

In another example embodiment, the first display apparatus 210 may be configured not to include the first sensor unit 216. In this case, the first display apparatus 210 may be configured to obtain conditions of the first display environment through other methods than the first sensor unit 216. For example, the first display apparatus 210 may obtain information input by a user through the first user input unit 214, or may obtain information received from another apparatus through the first communicator 211 or the first signal input/output unit 212.

The first processor 217 includes one or more hardware processors achieved by a central processing unit (CPU), a chipset, a microcontroller, circuit, etc. which are mounted on a printed circuit board (PCB). Alternatively, the first processor 217 may be provided as a system on chip (SoC). The first processor 217 include modules corresponding to various processes, such as a demultiplexer, a decoder, a scaler, an audio digital signal processor (DSP), an amplifier, etc., and some or all of the modules may be achieved by the SoC. For example, a demultiplexer, a decoder, a scaler, and the like module related to an image process may be achieved as an image processing SoC, and an audio DSP may be achieved as a chipset separated from the SoC.

Regarding the operation of the first processor 217 in an example embodiment, descriptions will be made later.

The second display apparatus 220 includes a second communicator 221, a second signal input/output unit 222 (or a second signal input/output interface), a second display unit 223 (or a second display), a second user input unit 224 (or a second user input interface), a second storage 225, a second sensor unit 226 (or a second sensor), and a second processor 227. The basic configuration of the second display apparatus 220 is substantially the same as that of the first display apparatus 210, and thus detailed descriptions will be omitted.

The second display apparatus 220 may communicate with or exchange data with the first display apparatus 210 through the second communicator 221 or the second signal input/output unit 222.

Further, the second sensor unit 226 includes one or more sensors configured to detect one or more among conditions of various attributes of the second display environment. Alternatively, the second display apparatus 220 may be configured not to include the second sensor unit 226, and may be configured to obtain information about conditions of the second display environment through other methods than the second sensor unit 226.

With this configuration, the system according to an example embodiment operates as follows. The system displays an image on the first display apparatus 210, obtains a first image-quality value by adjusting the image quality of the image displayed on the first display apparatus 210 according to a user input, identifies a second image-quality value corresponding to the display environment of the second display apparatus 220 based on a matching relationship between the display environment of the first display apparatus 210 and the first image-quality value, and displays an image having the identified second image-quality value on the second display apparatus 220. Here, there may be various conditions of the display environment, for example, an illumination value, a color temperature, ambient temperature, ambient humidity, a screen display angle, etc. or a combination of two or more among thereof.

According to an example embodiment of the disclosure, the illumination value or color temperature may be also called an ‘ambient light value,’ e.g., a first ambient light value of a first ambient light of the first display apparatus, and a second ambient light value of a second ambient light of the second display apparatus. Thus, when a user who is viewing an image of the first display apparatus 210 wants to adjust the image quality (e.g., a second image-quality value for the second display apparatus) of the image displayed on the second display apparatus 220 having a display environment different from that of the first display apparatus 210, through adjustment of a first image-quality value for the first display apparatus 210, the adjusted image quality intended by the user may be properly reflected in the image displayed on the second display apparatus 220 even if the user does not have to directly view the second display apparatus 220.

Alternatively, the system identifies the first image-quality value corresponding to the display environment of the first display apparatus 210 based on a relationship between a image-quality value of the image and the display environment of the second display apparatus 220, displays an image having the identified first image-quality value on the first display apparatus 210, obtains the second image-quality value by adjusting the image quality of the image displayed on the first display apparatus 210 in response to a user's input, and displays an image having the obtained second image-quality value on the second display apparatus 220. Thus, when the image of which the image quality is adjusted by a user who is viewing the first display apparatus 210 is displayed on the second display apparatus 220, the system may estimate the color tone of the image to be recognized by the user in the display environment of the second display apparatus 220 and reflect the estimated color tone in displaying the adjusted image.

Here, each operation of the system may be implemented by one of the first display apparatus 210 and the second display apparatus 220. It will be described in detail later which one of the first display apparatus 210 and the second display apparatus 220 carries out the operation. Further, according to an example embodiment of the disclosure, the first display apparatus 210 and the second display apparatus 220 communicating with each other may respectively include their own display units, but a single display apparatus may include two display units.

The system changes the image quality of the image displayed on the first display apparatus based on information about the first display environment of the first display apparatus 210 and information about the second display environment of the second display apparatus 220 and displays the image with the changed image quality on the first display apparatus 210. Accordingly, a user in the first display environment can recognize the image displayed on the second display apparatus 220 with the image quality to be recognized in the second display environment. The system obtains the image-quality value by changing the image quality of the image displayed on the first display apparatus 210 in response to a user's input, and changes the image quality of the image displayed on the second display apparatus 220 based on the obtained image-quality value.

For example, the first display apparatus 210 obtains data of an image displayed on the second display apparatus 220, and information about the second display environment, and displays the image of which the image quality is changed on the second display apparatus 220 based on the information about the second display environment. The first display apparatus 210 obtains the image-quality value by changing the image quality of the image displayed on the first display apparatus 210 in response to a user's input, and transmits the obtained image-quality value to the second display apparatus 220. Thus, the second display apparatus 220 changes the image quality of the image displayed on the second display apparatus 220 based on the received image-quality value.

Alternatively, the first display apparatus 210 may display an image by obtaining the data of the image displayed on the second display apparatus 220. The first display apparatus 210 obtains the image-quality value by changing the image quality of the image displayed on the first display apparatus 210 in response to a user's input, and transmits the obtained image-quality value to the second display apparatus 220. The second display apparatus 220 obtains information about the first display environment along with the image-quality value from the first display apparatus 210. The second display apparatus 220 changes the image quality of the image displayed thereon based on the obtained image-quality value and information about the first display environment.

Thus, when a user adjusts the image quality of the image on the second display apparatus 220 through the first display apparatus 210, the image having the adjusted image quality is displayed on the second display apparatus 220 according to the image quality intended by the user.

According to operation modes, the first display apparatus 210 may not obtain the image data from the second display apparatus 220. For example, in a case where the first display apparatus 210 displays data of the same content as the second display apparatus 220, because the first display apparatus 210 already has the data of the content displayed on the second display apparatus 220, the first display apparatus 210 does not necessarily need to obtain the data from the second display apparatus 220. Additionally, if the first display apparatus 210 does not have the image data of the second display apparatus 220, the image data may be obtained from various image sources such as a server, an optical media player, etc.

Below, a method of controlling the display apparatus corresponding to the foregoing operation will be described in detail.

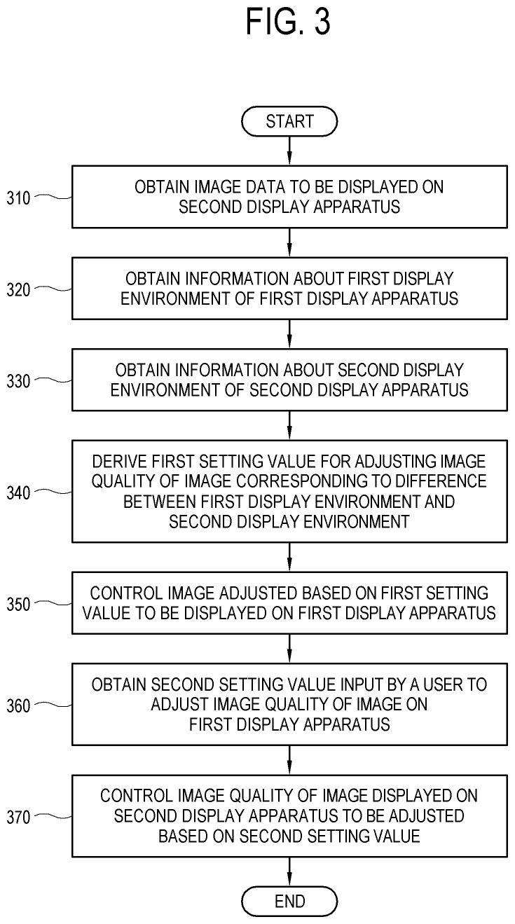

FIG. 3 is a flowchart of controlling a system according to an example embodiment of the disclosure.

As shown in FIG. 3, the following operation may be carried out by the first display apparatus or the second display apparatus of the system, or may be carried out by a separate image processing apparatus.

At operation 310, the system obtains image data of an image to be displayed on the second display apparatus.

At operation 320, the system obtains information about the first display environment of the first display apparatus.

At operation 330, the system obtains information about the second display environment of the second display apparatus.

At operation 340, the system obtains a first setting value for adjusting the image quality of the image based on a difference between the first display environment and the second display environment. According to an example embodiment of the disclosure, the difference between the first display environment and the second display environment may for example refer to a difference between an illumination value of the first display environment and an illumination value of the second display environment, and the operation 340 in an example embodiment may be regarded as a process of reflecting a difference between color tones recognized under the two display environments in the image-quality value according to the difference between the illumination values.

At operation 350, the system controls the image adjusted based on the first setting value to be displayed on the first display apparatus. In other words, the system reflects a difference between the first display environment and the second display environment in adjusting the image quality of the image, so that the conditions of the second display environment can be applied to the image displayed on the first display apparatus of the first display environment.

At operation 360, the system obtains the second setting value input by a user to adjust the image quality of the image on the first display apparatus. In this case, the system adjusts the image displayed on the first display apparatus based on the second setting value so that the user can check the image quality.

At operation 370, the system controls the image quality of the image displayed on the second display apparatus to be adjusted based on the second setting value.

The system according to an example embodiment of the disclosure may be carried out by two embodiments of the first display apparatus and the second display apparatus, that is, an embodiment in which the first display apparatus estimates the image quality recognized with respect to the image displayed on the second display apparatus, and an embodiment in which the second display apparatus estimates the image quality recognized with respect to the image displayed on the first display apparatus. In these embodiments, the first display apparatus refers to an apparatus being viewed by a user who adjusts an image, and the second display apparatus refers to an apparatus finally displaying the image which is adjusted by the user through the first display apparatus. Below, operation of the apparatuses according to the embodiments will be described.

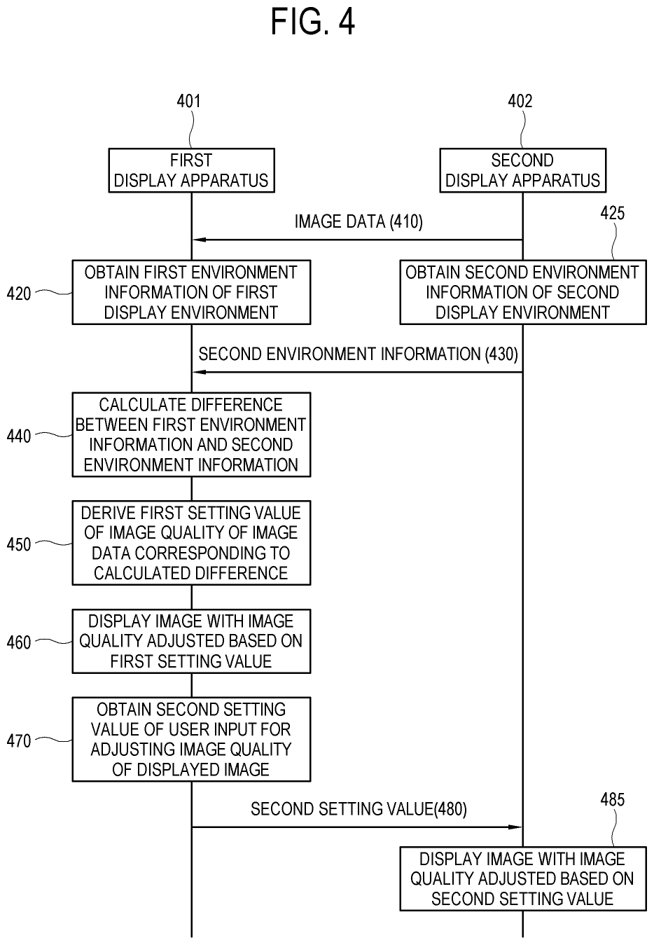

FIG. 4 illustrates operations of a first display apparatus to estimate image quality recognized with respect to an image displayed on a second display apparatus in a system according to an example embodiment of the disclosure.

As shown in FIG. 4, at operation 410, a first display apparatus 401 receives image data of an image, which is to be displayed on a second display apparatus 402, from the second display apparatus 402. It should be noted that this is merely an example and the disclosure is not limited. For example, the first display apparatus 401 may not be required to receive the image data from the second display apparatus 402, and the first display apparatus 401 may alternatively obtain the image data from a separate content source or the image data stored therein.

At operation 420, the first display apparatus 401 acquires first environment information about the conditions of the first display environment. For example, the first environment information may include an illumination level (hereinafter also referred to as an ‘illumination value’), color temperature, ambient temperature, ambient humidity, a screen display angle, etc. of the first display environment or a combination of two or more thereof. The first display apparatus 401 may obtain the first environment information from a detection result of its own illumination sensor or the like by way of example.

Similarly, at operation 425, the second display apparatus 402 acquires second environment information about the conditions of the second display environment. For example, the second environment information may include an illumination level, color temperature, ambient temperature, ambient humidity, an screen display angle, etc. of the second display environment or a combination of two or more thereof. The second display apparatus 402 may obtain the second environment information from a detection result of its own illumination sensor or the like by way of example.

At operation 430, the first display apparatus 401 acquires the second environment information from the second display apparatus 402. For calculation between the first environment information and the second environment information, the illumination level or the like factor involved in the first environment information and the second environment information are given as values quantified in the same dimensions.

At operation 440, the first display apparatus 401 calculates a difference between the first environment information and the second environment information. The difference between the first environment information and the second environment information may, for example, correspond to a difference in the illumination level between the first display environment and the second display environment.

At operation 450, the first display apparatus 401 obtains a first setting value for image quality of image data corresponding to the calculated difference. Here, the first setting value may be obtained through a preset lookup table or an algorithm including a mathematical function. A detailed example of obtaining the first setting value will be described later. The first setting value may for example be provided as an adjustment value for a screen brightness level of an image corresponding to a difference between the illumination level of the first display environment and the illumination level of the second display environment.

At operation 460, the first display apparatus 401 adjusts the image quality of the image based on the first setting value and displays the image having the adjusted image quality. For example, the first display apparatus 401 adds the adjustment value to the screen brightness level of the image data. In other words, the first display apparatus 401 simulates the image quality, which will be recognized by a human with respect to the image under the second display environment, in the first display environment, and displays the image to be recognized with a color tone corresponding to the second display environment.

At operation 470, the first display apparatus 401 obtains the second setting value input by a user to adjust the image quality of the displayed image, and adjusts the image quality of the image based on the obtained second setting value. The user may adjust the brightness of an image through the user input unit, while viewing the image displayed on the first display apparatus 401.

At operation 480, the first display apparatus 401 transmits the second setting value to the second display apparatus 402.

At operation 485, the second display apparatus 402 adjusts the image quality of the image data based on the second setting value, and displays the image based on the adjusted image data.

As described above, the first display apparatus 401 estimates the screen brightness of the image displayed under the second display environment, and displays the image, of which the screen brightness is adjusted reflecting the estimated result, to be provided to the user under the first display environment. Thus, a user adjusts the image quality by recognizing the image with the same color tone as that of the second display environment even in the first display environment, and it is thus easy for the user to adjust the image quality without changing the adjustment place.

In the foregoing embodiment, the illumination level is described as an example of the display environment. However, the display environment according to an example embodiment of the disclosure is not limited to this example. As mentioned above, not only the illumination level but also various values such as the color temperature, the ambient temperature, the ambient humidity, the screen display angle, etc. may be given as the display environment. Further, the foregoing embodiment describes the screen brightness as an example of the image quality, but the image quality is not limited to the screen brightness. According to an example embodiment of the disclosure, the image quality may be varied depending on the display environments, and for example include brightness, a gamma curve, color, contrast, etc. of an image or a combination of two or more thereof. Various examples of the display environment and the image quality (or the image-quality value) according to such an example embodiment of the disclosure may be applied to not only the foregoing embodiments but also the following embodiments. In other words, even if a specific example of the display environment or the image quality (value) is described in a certain embodiment of the disclosure, it will be understood that various examples as described above are applicable as well as the specific example.

Various examples may be given for the first setting value corresponding to the difference between the first environment information and the second environment information, and the method of adjusting the image quality of the image based on the first setting value. Below, a method of adjusting image quality of an image based on a first setting value corresponding to a difference between first environment information and second environment information will be described by way of example.

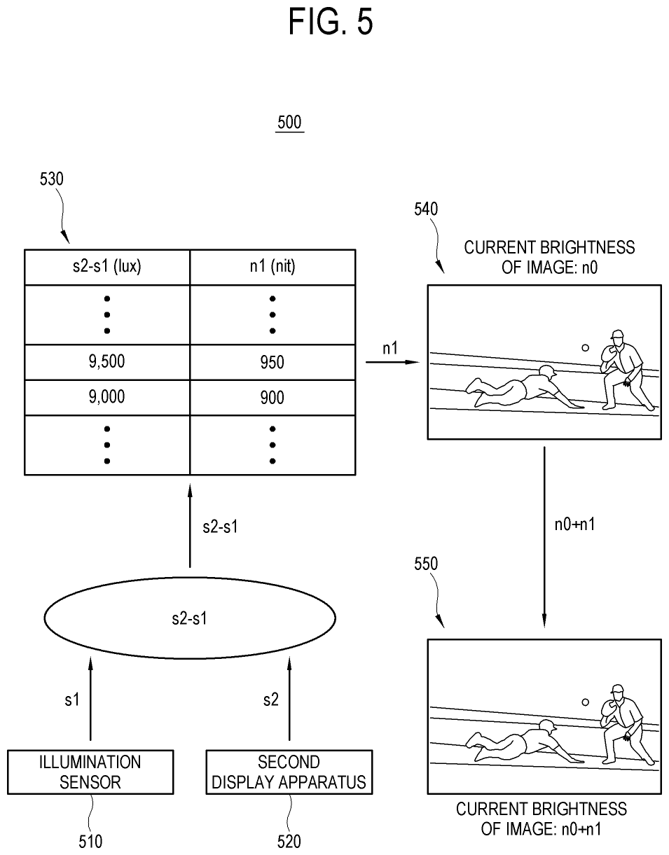

FIG. 5 illustrates a principle of adjusting an illumination level of an image based on difference in an illumination level between display environments in a system according to an example embodiment of the disclosure.

As shown in FIG. 5, a first display apparatus 500 obtains an illumination level s1 of the first display environment from an illumination sensor 510, and obtains an illumination level s2 of the second display environment from a second display apparatus 520. The first display apparatus 500 calculates a difference, i.e. (s2-s1) between the illumination level of the first display environment and the illumination level of the second display environment. For example, in a case of s1=500 lux and s2=10,000 lux, the difference is (s2-s1)=9,500 lux.

The first display apparatus 500 calls a preset lookup table (LUT) 530. In the LUT 530, a plurality of first setting values n1 are previously tabulated corresponding to a plurality of (s2-s1) values, respectively. The LUT 530 may be stored in the first display apparatus 500 at a manufacturing stage based on various experiments, or may be received from an external memory, a server or the like external apparatus and stored in the first display apparatus 500. In this embodiment, the LUT 530 is given by way of example, but a preset function or algorithm may be employed instead of the LUT 530.

Each of the first setting values n1 in the LUT 530 refers to a value for adjusting an illumination level of an image 540. However, the configuration of the LUT 530 is not limited to a certain form. Alternatively, brightness values of an image 550 to be finally adjusted, or adjustment values to be added or subtracted to and from a current brightness value n0 of the image 540 may be tabulated in the LUT 530. In this embodiment, the latter case will be described. For example, in a case of (s2-s1)=9,500 lux, the first display apparatus 500 obtains a first setting value n1=950 nit corresponding to 9,500 lux by searching the LUT 530.

The first display apparatus 500 adjusts the brightness level of the image 540 by adding the first setting value n1 to the current brightness level n0 of the image 540. For example, in a case of n0=300 nit, the brightness level is adjusted into (n0+n1)=1,250 nit. The first display apparatus 500 displays the image 540 with 1,250 nit into which the brightness level of the image 540 is finally adjusted.

In such a manner, the first display apparatus 500 obtains the adjustment value for the screen brightness corresponding to the difference between the illumination level of the first display environment and the illumination level of the second display environment, and adjusts the screen brightness of the image on the first display apparatus 500 based on the obtained adjustment value.

This embodiment describes that the condition of the display environment is the illumination and the brightness of the image is adjusted among the attributes for the image quality of the image. However, various examples may be given for the condition of the display environment and the corresponding attribute for the image quality of the image.

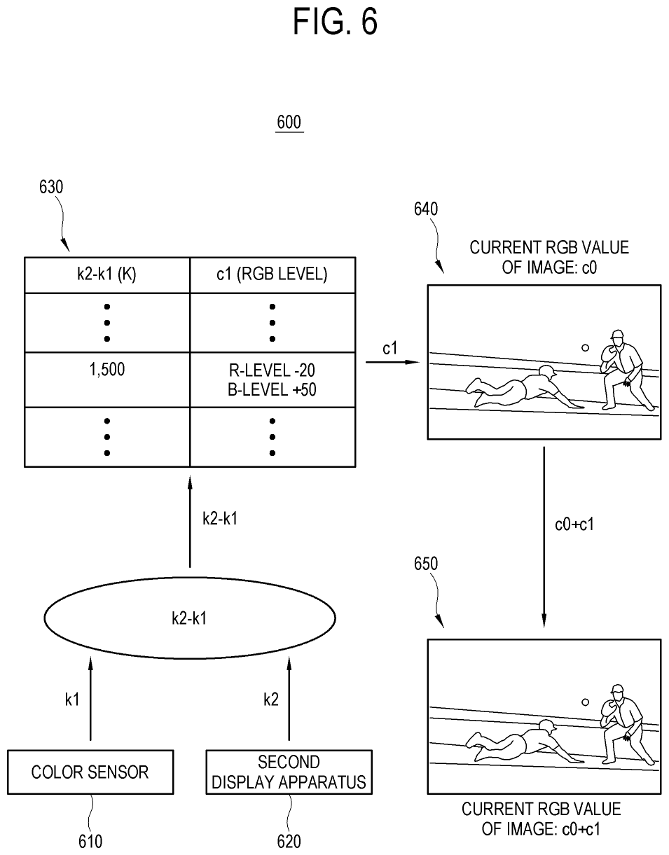

FIG. 6 illustrates a principle of adjusting an RGB level of an image based on difference in color temperature between display environments in a system according to an example embodiment of the disclosure.

As shown in FIG. 6, a color temperature k1 of the first display environment is obtained from a color sensor 610, and a color temperature k2 of the second display environment is obtained from a second display apparatus 620 (e.g., a color sensor of the second display apparatus 620). The first display apparatus 600 calculates a difference, i.e. (k2-k1) between the color temperature of the first display environment and the color temperature of the second display environment. For example, in a case of k1=5,000 K and k2=6,500 K, the difference is (k2-k1)=1,500 K.

The first display apparatus 600 calls a preset LUT 630. In the LUT 630, a plurality of first setting values cl are previously tabulated corresponding to a plurality of (k2-k1) values, respectively. The LUT 630 in this embodiment may also be given similarly to that of the previous embodiment.

Each of the first setting values c1 in the LUT 630 refers to a value for adjusting the RGB value of an image 640. For example, adjustment values are designated for an R-level, a G-level and a B-level, respectively. For example, in a case of (k2-k1)=1,500 K, the first display apparatus 600 retrieves the first setting value corresponding to 1,500 K from the LUT 630.

The first display apparatus 600 adjusts the RGB value of the image 640 by adding the first setting value cl to the current RGB value c0 of the image 640. For example, when the first setting value cl is configured as an R-level of ‘−20’ and a B-level of ‘+50’, the first display apparatus 600 performs adjustment to decrease the R-level by ‘20’ and increase the B-level by ‘50’ in the RGB level corresponding to the current RGB value c0 of the image 640, and displays an adjusted image 650.

In such a manner, the first display apparatus 600 obtains the adjustment value for the RGB value corresponding to the difference between the color temperature of the first display environment and the color temperature of the second display environment, and adjusts the RGB value of the image based on the obtained adjustment value, thereby displaying the adjusted image.

The foregoing embodiments describe that the display apparatus considers only one of the ambient light or the ambient color temperature among many conditions of the display environment. However, the display apparatus may take both the ambient light and the ambient color temperature into account. In the LUT, the first setting values may for example be tabulated corresponding to both the difference in the illumination level between the first display environment and the second display environment, and the difference in the color temperature between the first display environment and the second display environment. Alternatively, the LUT may be configured by the same principle with respect to even three or more conditions of the display environment.

The foregoing embodiments describe that the display apparatus is configured to employ the sensor in detecting the ambient light, the ambient color temperature and the like conditions of the display environment. However, the display apparatus may exclude the sensor and be configured to provide an interface for allowing a user to input the condition of the display environment. In this regard, descriptions will be made below. Here, the display apparatus may be one of the first display apparatus and the second display apparatus described in the foregoing embodiments.

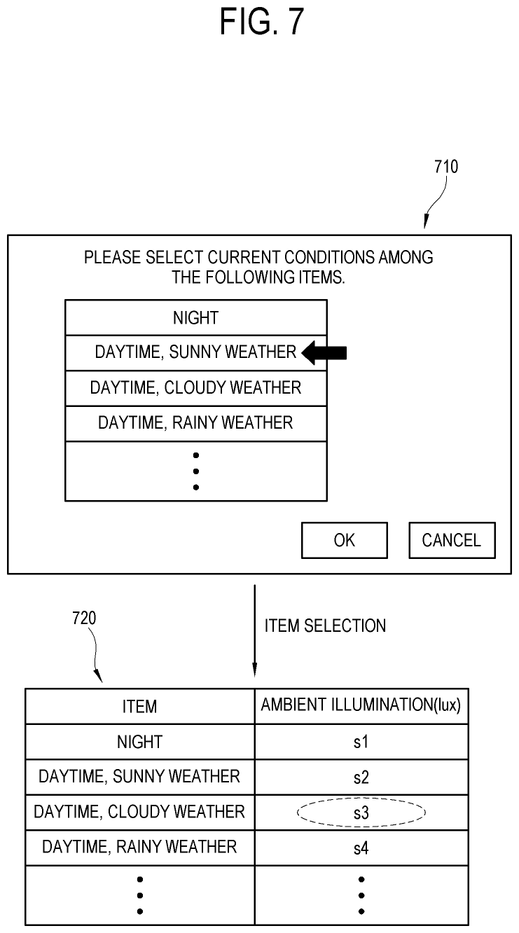

FIG. 7 illustrates a principle that a display apparatus according to an example embodiment of the disclosure identifies ambient light among conditions of display environments based on a user's input.

As shown in FIG. 7, the display apparatus displays a user interface (UI) or image 710 for allowing a user to input a condition of the display environment. The image 710 shows a plurality of items to be selectable respectively corresponding to a plurality of different preset conditions of the display environment. Here, the conditions of the display environment may include one or more among many attributes of the display environment. In this embodiment, it will be described that an item is displayed for selecting an illumination level of the display environment.

The image 710 includes a plurality of items related to an ambient lighting state (hereinafter, also referred to as ‘information of ambient light’). The ambient lighting state may be influenced by external natural light such as current time, weather, etc., artificial light such as indoor light, etc., and the like various factors. For example, the items include night and day; sunny, cloudy and rainy weathers; AM and PM; and the like combination of various different conditions. For example, the items may be divided into night, sunny weather in daytime, cloudy weather in daytime, rainy weather in daytime, etc. Alternatively, the items may include indoor lighting conditions according to the kinds of electric light, such as candlelight, incandescent light, tungsten light, halogen light, fluorescent light, etc.

Such content of the items allows a user to easily determine the current conditions and select a certain item. It should be noted that it is technically possible for a user to input the illumination of the current display environment as a numerical value, but it is generally difficult for the user to know the illumination of the current display environment. Thus, the items are provided based on a combination of time, weather, the kind of electric light, or the like a user can easily determine, and an LUT 720 in which the ambient light is tabulated corresponding to each mapping item is provided in the display apparatus.

When a user selects one among a plurality of items shown in the image 710, the display apparatus retrieves an illumination level corresponding to the selected item from the LUT 720, and identifies the retrieved illumination level as the illumination level of the display environment. For example, when a user selects an item of “sunny weather in daytime”, the display apparatus identifies an ambient light level s2, which corresponds to the item of “sunny weather in daytime” in the LUT 720, as the illumination level of the display environment.

According to such a principle, the display apparatus may also identify another condition such as a color temperature based on a user's input.

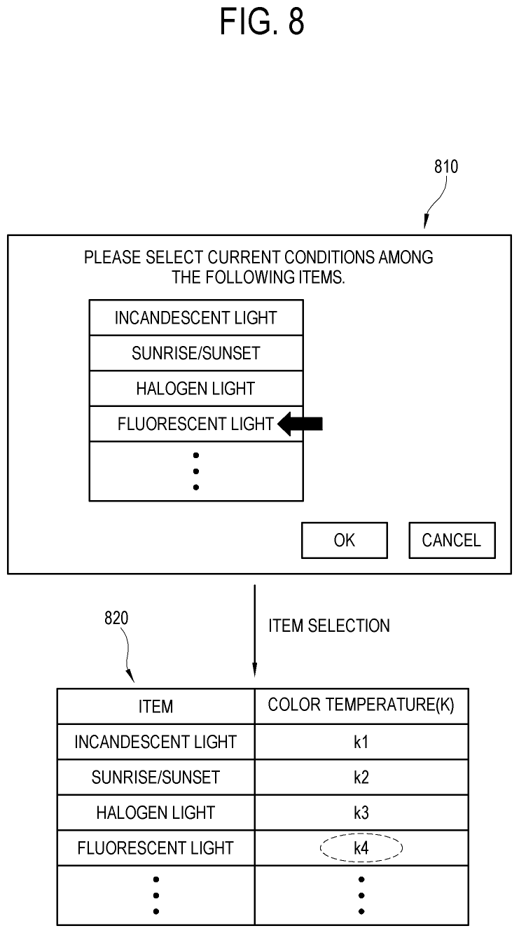

FIG. 8 illustrates a principle that the display apparatus according to an example embodiment of the disclosure identifies an ambient color temperature among conditions of display environments based on a user's input.

As shown in FIG. 8, the display apparatus displays an image 810 for allowing a user to input a condition of the display environment. The image 810 shows a plurality of items to be selectable respectively corresponding to a plurality of different preset lighting conditions of the display environment. In this embodiment, it will be described that an item is displayed for selecting a color temperature of the display environment.

The image 810 includes a plurality of items related to the current time and weather. Such content of the items is similar to that of the foregoing embodiment, but an LUT 820 in this embodiment is different from that of the foregoing embodiment. That is, in the LUT 820, the condition of the display environment corresponding to the item is not illumination level but the color temperature.

In the LUT 820, the color temperatures are tabulated corresponding to the plurality of items about the lighting conditions, respectively. When a user selects a certain item through the image 810, the display apparatus retrieves a color temperature value corresponding to the selected item from the LUT 820. The display apparatus identifies the retrieved value as the color temperature of the display environment. For example, when a user selects an item of “fluorescent light”, a color temperature k4 in the LUT 820 corresponding to “the fluorescent light” is identified as the color temperature of the display environment.

The foregoing embodiments describe that the display apparatus identifies the illumination level or color temperature of the display environment, but the display apparatus may identify two or more attributes of the display environment. For example, when a user selects one of the items through an image, the display apparatus may retrieve both the illumination level and the color temperature corresponding to the selected item from the LUT.

The display apparatus may provide an interface for allowing a user to input a condition of the display environment, but may receive information about the condition of the display environment through the server without receiving the user's input. For example, the display apparatus may receive information about real-time weather of National Weather Service through the communicator, and identify an ambient light level and a color temperature corresponding to the weather as the illumination level and color temperature of the display environment.

The foregoing embodiment describes that the first display apparatus estimates the image quality recognized with respect to the image displayed on the second display apparatus. On the other hand, it will be described below that the second display apparatus estimates image quality recognized with respect to an image displayed on the first display apparatus.

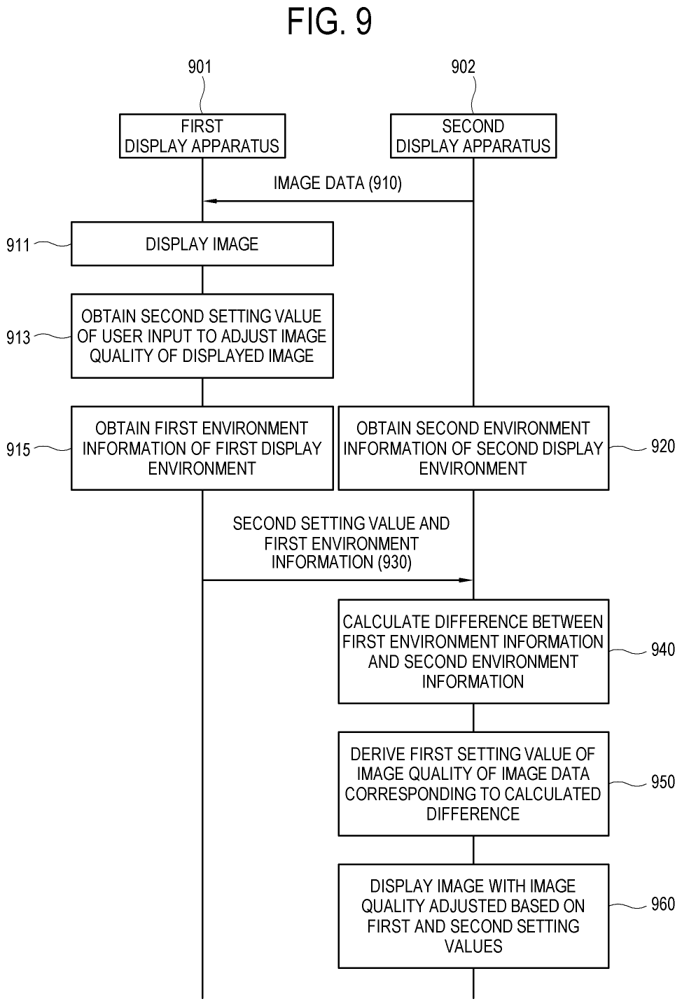

FIG. 9 illustrates operations of estimating by a second display apparatus image quality recognized with respect to an image displayed on a first display apparatus in a system according to an example embodiment of the disclosure.

As shown in FIG. 9, at operation 910, a second display apparatus 902 transmits image data of an image to be displayed to a first display apparatus 901.

At operation 911, the first display apparatus 901 displays the image based on the image data received from the second display apparatus 902.

At operation 913, the first display apparatus 901 obtains a second setting value input by a user to adjust the image quality of the displayed image.

At operation 915, the first display apparatus 901 obtains first environment information about a condition of a first display environment. The first display apparatus 901 may obtain the first environment information from a detection result of its own sensor.

Similarly, at operation 920, the second display apparatus 902 obtains second environment information about a condition of a second display environment. The second display apparatus 902 may obtain the second environment information from a detection result of its own sensor.

At operation 930, the second display apparatus 902 receives the second setting value and the first environment information from the first display apparatus 901.

At operation 940, the second display apparatus 902 calculates a difference between the first display environment and the second display environment, i.e. a difference between the first environment information and the second environment information.

At operation 950, the second display apparatus 902 obtains the first setting value for the image quality of the image data corresponding to the calculated difference.

At operation 960, the second display apparatus 902 adjusts and displays the image quality of the image based on the first setting value and the second setting value.

In this manner, when the image quality of the image on the second display apparatus 902 is adjusted based on the second setting value adjusted by a user of the first display apparatus 901, the second display apparatus 902 adjusts the image quality of the image in the second display environment by reflecting the color tone of the image, which would have been recognized by the user under the first display environment, and displays the image with the adjusted image quality.

The foregoing embodiments describe that the system includes the first display apparatus and the second display apparatus, and one of the first display apparatus and the second display apparatus reflects the image quality recognized with respect to the image displayed on the other display apparatus. However, the disclosure is not limited. For example, alternatively, an image processing apparatus separately provided to control the first display apparatus and the second display apparatus may be configured to perform the foregoing operation. In this regard, descriptions will be made below.

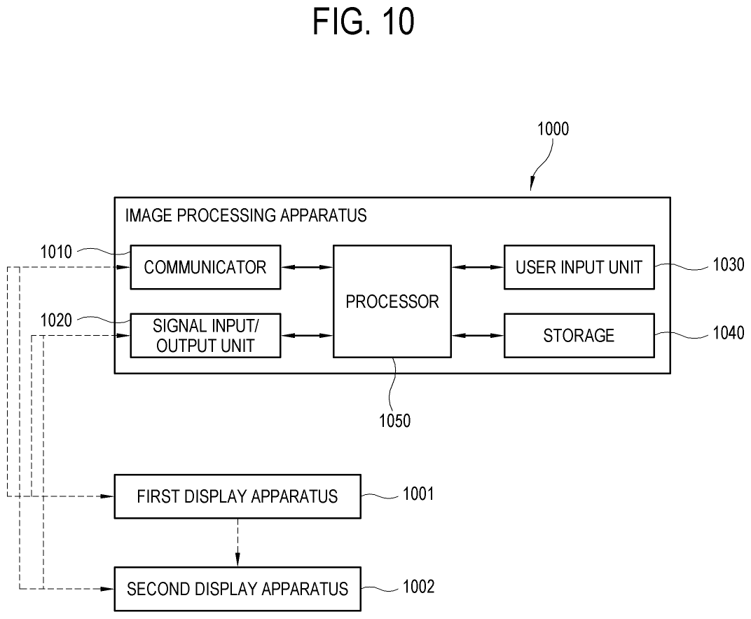

FIG. 10 is a block diagram of an image processing apparatus for controlling a plurality of display apparatuses in a system of the disclosure.

As shown in FIG. 10, the system according to this embodiment includes an image processing apparatus 1000, a first display apparatus 1001, and a second display apparatus 1002. The basic configurations of the first display apparatus 1001 and the second display apparatus 1002 are equivalent to those of the foregoing embodiments, and thus detailed descriptions thereof will be omitted.

The image processing apparatus 1000 includes a communicator 1010, a signal input/output unit 1020 (or a signal input/output interface), a user input unit 1030 (or a user input interface), a storage 1040, and a processor 1050. The image processing apparatus 1000 may serve to provide image data to the first display apparatus 1001 and the second display apparatus 1002 and include a set-top box or a content source, or may serve to control each operation of the first display apparatus 1001 and the second display apparatus 1002 and include a control box.

The communicator 1010 refers to an interactive communication circuitry including at least one among a communication module, a communication chip and the like elements corresponding to various wired and wireless communication protocols. The signal input/output unit 1020 is connected one-to-one or one-to-many to a predetermined external apparatus such as the first display apparatus 1001 and the second display apparatus 1002, for example by a wire, thereby receiving or outputting data with regard to the corresponding external apparatus.

In this embodiment, the image processing apparatus 1000 is provided to communicate with each of the first display apparatus 1001 and the second display apparatus 1002 through one of the communicator 1010 and the signal input/output unit 1020. Alternatively, the image processing apparatus 1000 may be provided to communicate with the first display apparatus 1001 through one of the communicator 1010 and the signal input/output unit 1020, and the first display apparatus 1001 may be provided to communicate with the second display apparatus 1002.

The user input unit 1030 includes various kinds of input interfaces for allowing a user to enter an input.

The storage 1040 is accessed by the processor 1050, and performs operations such as reading, recording, modifying, deleting, updating, etc. for data under control of the processor 1050.

The processor 1050 performs calculation and process for general operation of the image processing apparatus 1000. Below, the operation of the image processing apparatus 1000 performed by the processor 1050 in this embodiment will be described.

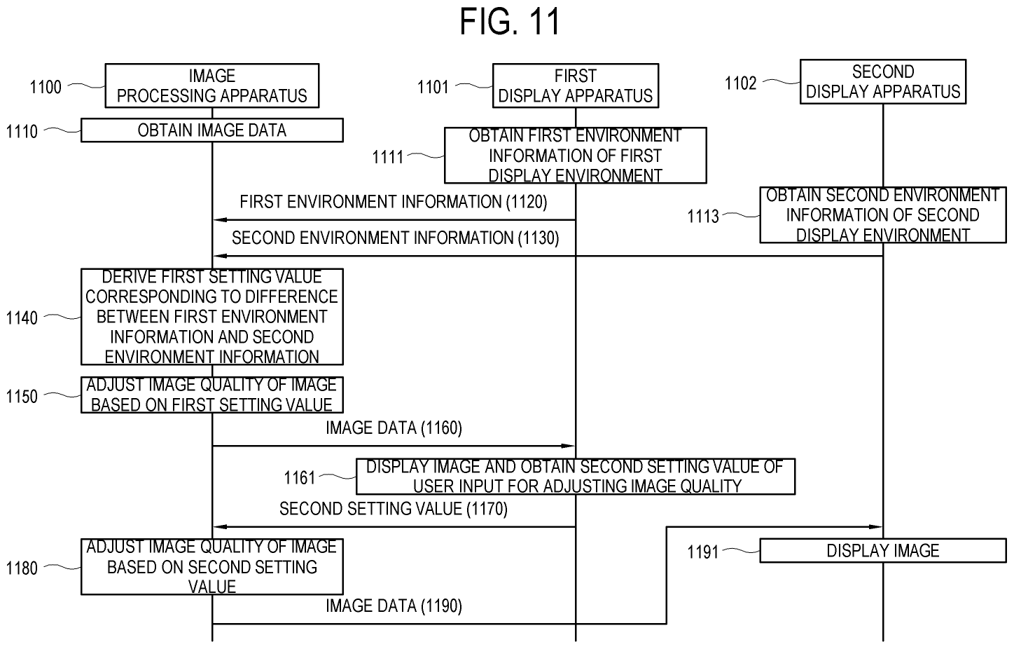

FIG. 11 illustrates operations of an image processing apparatus estimating image quality recognized with respect to an image displayed on a first display apparatus in a system according to an example embodiment of the disclosure.

As shown in FIG. 11, at operation 1110, an image processing apparatus 1100 obtains image data. When the image processing apparatus 1100 is an image source, the image processing apparatus 1100 may obtain the image data stored therein or reproduced autonomously, or may receive the image data from the outside.

At operation 1111, a first display apparatus 1101 obtains first environment information about a condition of a first display environment.

Similarly, at operation 1113, a second display apparatus 1102 obtains second environment information about a condition of a second display environment. Each environment information may be obtained from detection results of sensors respectively provided in the first display apparatus 1101 and the second display apparatus 1102, but the disclosure is not limited thereto.

At operation 1120, the image processing apparatus 1100 receives the first environment information from the first display apparatus 1101.

At operation 1130, the image processing apparatus 1100 receives the second environment information from the second display apparatus 1102. It should be noted that the method of obtaining the first environment information and the second environment information by the image processing apparatus 1100 is not limited to the foregoing operation. For example, the first environment information and the second environment information may be obtained based on a user's input.

At operation 1140, the image processing apparatus 1100 obtains a first setting value for image quality of image data corresponding to a difference between the first environment information and the second environment information.

At operation 1150, the image processing apparatus 1100 adjusts the image quality of the image based on the first setting value. The method of obtaining the first setting value and the method of adjusting the image quality based on the first setting value are the same as described above in the foregoing embodiment.

At operation 1160, the image processing apparatus 1100 transmits the image data, of which the image quality of the image is adjusted, to the first display apparatus 1101. This is to allow a user who is viewing the first display apparatus 1101 to adjust the image quality of the image.

At operation 1161, the first display apparatus 1101 displays the image, and adjusts the image quality of the image based on a second setting value input by the user. Thus, the user can adjust the image quality as desired while viewing the image displayed on the first display apparatus 1101.

At operation 1170, the image processing apparatus 1100 receives the second setting value from the first display apparatus 1101.

At operation 1180, the image processing apparatus 1100 adjusts the image quality of the image based on the second setting value.

At operation 1190, the image processing apparatus 1100 transmits the adjusted image data to the second display apparatus 1102. Alternatively, the image processing apparatus 1100 may not adjust the image data based on the second setting value, but transmit the second setting value and the image data to the second display apparatus 1102, so that the second display apparatus 1102 may adjust the image data based on the second setting value.

At operation 1191, the second display apparatus 1102 displays an image based on the received image data.

As described above in the foregoing embodiments, the image quality of an image displayed on a display apparatus under a certain display environment may be adjusted under another display environment (hereinafter, referred to as an ‘image-quality adjusting operation’) by reflecting the display environment under which the image is displayed on the display apparatus. The image-quality adjusting operation may be always performed whenever the image quality of the image needs to be adjusted, or may be selectively performed under a specific condition.

The foregoing image-quality adjusting operation has a prominent effect when a difference between the illumination level of the first display environment and the illumination level of the second display environment is relatively large, but has an inconspicuous effect when the difference is relatively small. Taking this into account, the image-quality adjusting operation may be performed when the difference is large, but may not be performed when the difference is small. In this regard, descriptions will be made below.

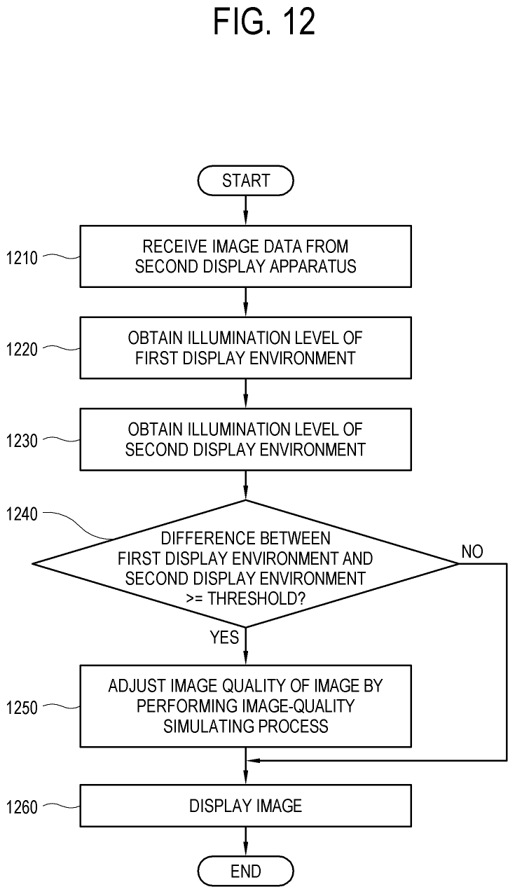

FIG. 12 is a flowchart of selectively performing an image-quality adjusting operation based on difference in an illumination level by a first display apparatus according to an example embodiment of the disclosure.

The operations as shown in FIG. 12 may be performed by the processor of the first display apparatus.

At operation 1210, the first display apparatus receives image data from a second display apparatus.

At operation 1220, the first display apparatus obtains an illumination level of a first display environment.

At operation 1230, the first display apparatus obtains an illumination level of a second display environment from the second display apparatus.

At operation 1240, the first display apparatus identifies whether a difference between the first display environment and the second display environment is equal to or greater than a preset threshold.

When the difference is equal to or greater than the threshold, at operation 1250, the first display apparatus adjusts the image quality of the image of the second display apparatus by performing the image-quality adjusting operation (or image-quality simulating process) on the image data from the second display apparatus. The image-quality adjusting operation is the same as that described above in the foregoing embodiment, and thus descriptions thereof will be omitted.

On the other hand, when the difference is not greater than the threshold, the first display apparatus does not perform the image-quality adjusting operation.

At operation 1260, the first display apparatus displays an image based on the image data from the second display apparatus according to a result of the image-quality adjusting operation. Thus, a user can adjust the image quality of the image of the second display apparatus while viewing the corresponding image displayed on the first display apparatus. The subsequent operation is the same as that described above in the foregoing embodiment.

Thus, the first display apparatus according to this embodiment performs the image-quality adjusting operation only when there is a large difference in the illumination level between the first display environment and the second display environment. Further, the image-quality adjusting operation is not carried out when its effect is not prominent, thereby decreasing the load of the first display apparatus.

In addition to the method of directly measuring a difference in an illumination level between the first display environment and the second display environment as described in the foregoing embodiment, the current time may be used in determining whether to perform the image-quality adjusting operation. In this regard, descriptions will be made below.

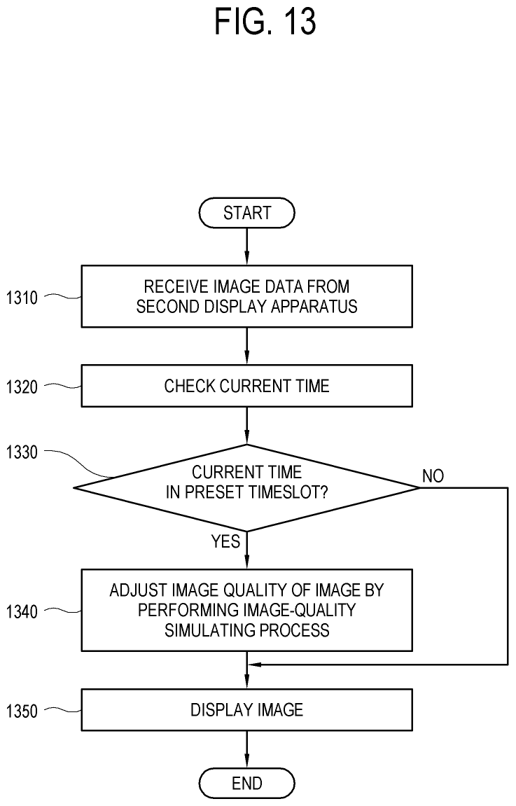

FIG. 13 is a flowchart of selectively performing an image-quality adjusting operation based on a timeslot by a first display apparatus according to an example embodiment of the disclosure.

The operations as shown in FIG. 13 may be performed by the processor of the first display apparatus.

At operation 1310, the first display apparatus receives image data from the second display apparatus.

At operation 1320, the first display apparatus checks a current time.

At operation 1330, the first display apparatus identifies whether the current time is in a preset timeslot. For example, the first display apparatus identifies whether the current time is in the daytime during which the difference in the illumination level between the first display environment and the second display environment is relatively large.

When the current time is in a preset timeslot, at operation 1340, the first display apparatus performs the image-quality adjusting operation on the image data of the second display apparatus, thereby adjusting the image quality of the image. The image-quality adjusting operation is the same as that described above in the foregoing embodiment, and thus detailed descriptions thereof will be omitted.

On the other hand, when the current time is out of the preset timeslot, the first display apparatus does not carry out the image-quality simulating process.

At operation 1350, the first display apparatus displays an image based on the image data from the second display apparatus. Thus, a user can adjust the image quality of the image while viewing the corresponding image displayed on the first display apparatus. The subsequent operation is the same as that described above in the foregoing embodiment.

The foregoing embodiments describe that the first display and the second display are provided as separate apparatuses. However, the first display, the second display and the processor for controlling the first and second displays may be achieved by a single apparatus, and an example embodiment related to such a configuration will be described below.

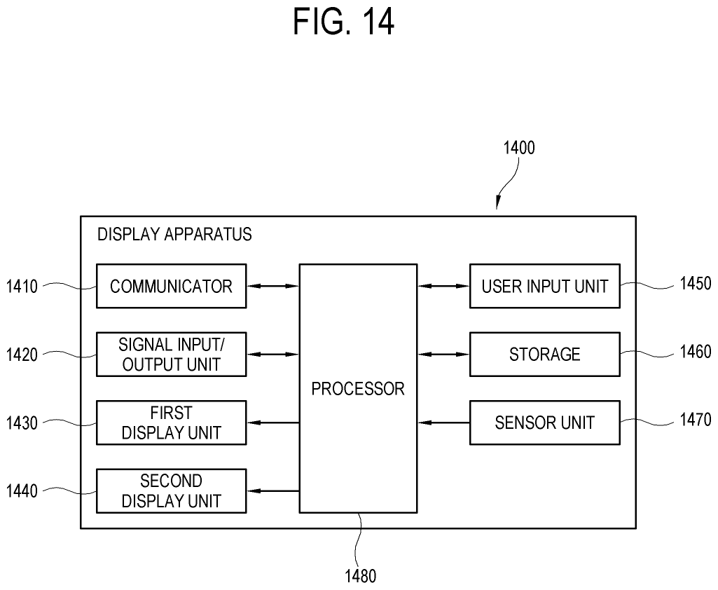

FIG. 14 is a block diagram of a display apparatus according to an example embodiment of the disclosure.

As shown in FIG. 14, a display apparatus 1400 according to an example embodiment includes a communicator 1410, a signal input/output unit 1420 (or a signal input/output interface), a first display unit 1430 (or a first display), a second display unit 1440 (or a second display), a user input unit 1450 (or a user input interface), a storage 1460, a sensor unit 1470 (or a sensor), and a processor 1480. These elements of the display apparatus 1400 have a basic configuration similar to those of the display apparatuses according to the foregoing embodiments.

However, in this embodiment, the display apparatus 1400 includes the first display unit 1430 present in the first display environment, the second display unit 1440 preset in the second display environment, and the processor 1480 for processing an image to be displayed in each of the first display unit 1430 and the second display unit 1440. Further, the sensor unit 1470 may detect each of the first display environment and the second display environment. The first display environment and the second display environment are different in conditions from each other.

Below, the operation of the display apparatus 1400 performed by the processor 1480 will be described according to an example embodiment.

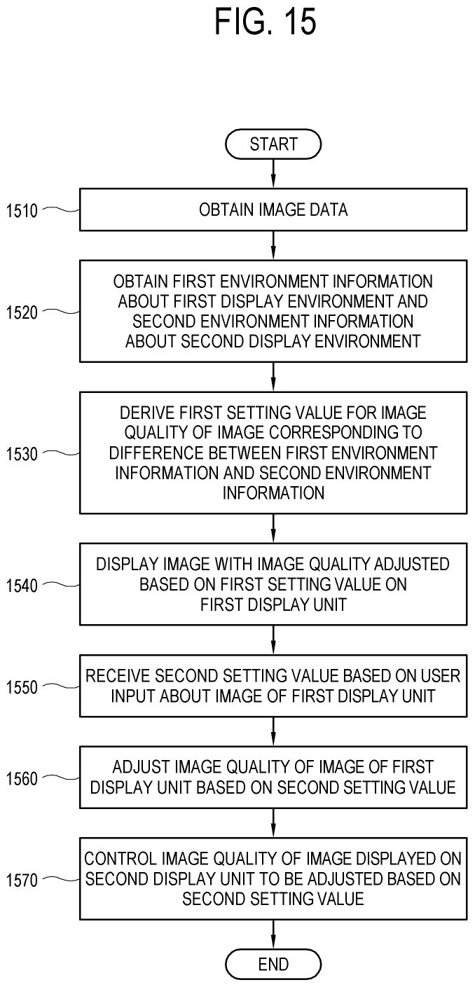

FIG. 15 illustrates operations of a display apparatus according to an example embodiment of the disclosure to reflect image quality recognized with respect to an image displayed on a first display unit in adjusting image quality of a second display unit.

As shown in FIG. 15, at operation 1510, the display apparatus obtains image data.

At operation 1520, the display apparatus obtains first environment information about a condition of a first display environment and second environment information about a condition of a second display environment.

At operation 1530, the display apparatus obtains a first setting value for image quality of image data corresponding to a difference between the first environment information and the second environment information.

At operation 1540, the display apparatus adjusts the image quality of the image based on the first setting value and displays the adjusted image on the first display unit.

At operation 1550, the display apparatus receives a second setting value based on a user's input with respect to the image of the first display.

At operation 1560, the display apparatus adjusts the image quality of the image displayed on the first display unit based on the second setting value.

At operation 1570, the display apparatus adjusts the image quality of the image displayed on the second display unit based on the second setting value.

Thus, the display apparatus adjusts the image quality of the image, which is displayed with the color tone different from that of the first display environment, in the second display environment, while considering the color tone recognized from the image being viewed by a user under the first display environment, thereby allowing the user to adjust the image quality of the image under the second display environment more closely to the image quality adjusted based on the image being actually viewed by the user under the first display environment.

The operations of the apparatus described in the foregoing embodiments may be performed by artificial intelligence provided in the corresponding apparatus. The artificial intelligence may be applied to various general systems by utilizing a machine learning algorithm. An artificial intelligence system refers to a computer system with intelligence of a human or being second to a human. In such a system, a machine, an apparatus or a system autonomously performs learning and identifying and is improved in accuracy of recognition and identification based on accumulated experiences. The artificial intelligence is based on machine learning technology, such as deep learning, and algorithms based on an algorithm of autonomously classifying and learning features of input data, and copying perception, identification and the like functions of a human brain.

The artificial intelligence technology may include, for example, at least one of language comprehension technology for recognizing a language and a text of a human, visual recognition technology for recognizing an object like a human sense of vision, inference and prediction technology for identifying information and logically making inference and prediction, knowledge representation technology for processing experience information of a human into knowledge data, and motion control technology for controlling a vehicle's automatic driving or a robot's motion.

Here, language comprehension refers to technology of recognizing, applying and processing a human's language or text, and includes natural language processing, machine translation, conversation system, question and answer, voice recognition and synthesis, etc.

Inference and prediction refer to technology of identifying information and logically making prediction, and includes knowledge- and probability-based inference, optimized prediction, preference-based plan, recommendation, etc.

Knowledge representation refers to technology of automating a human's experience information into knowledge data, and includes knowledge building such as data creation and classification, knowledge management such as data utilization, etc.

The methods according to the foregoing embodiments may be achieved in the form of a program command that can be implemented in various computers, and recorded in a computer readable medium. Such a computer readable medium may include a program command, a data file, a data structure or the like, or a combination thereof. For example, the computer readable medium may be stored in a voltage or nonvolatile storage such as a read only memory (ROM) or the like, regardless of whether it is deletable or rewritable, for example, a RAM, a memory chip, a device or integrated circuit (IC) or the like memory, or an optically or magnetically recordable or machine (e.g., a computer)-readable storage medium, for example, a compact disk (CD), a digital versatile disk (DVD), a magnetic disk, a magnetic tape or the like. It will be appreciated that a memory, which can be included in a mobile terminal, is an example of the machine-readable storage medium suitable for storing a program having instructions for realizing the embodiments. The program command recorded in the storage medium may be specially configured according to the example embodiments, or may be publicly known and available to those skilled in the art of computer software.

At least one of the components, elements, modules or units described herein may be embodied as various numbers of hardware, software and/or firmware structures that execute respective functions described above, according to an example embodiment. For example, at least one of these components, elements or units may use a direct circuit structure, such as a memory, a processor, a logic circuit, a look-up table, etc. that may execute the respective functions through controls of one or more microprocessors or other control apparatuses. Also, at least one of these components, elements or units may be specifically embodied by a module, a program, or a part of code, which contains one or more executable instructions for performing specified logic functions, and executed by one or more microprocessors or other control apparatuses. Also, at least one of these components, elements or units may further include or implemented by a processor such as a central processing unit (CPU) that performs the respective functions, a microprocessor, or the like. Two or more of these components, elements or units may be combined into one single component, element or unit which performs all operations or functions of the combined two or more components, elements of units. Also, at least part of functions of at least one of these components, elements or units may be performed by another of these components, element or units. Further, although a bus is not illustrated in the block diagrams, communication between the components, elements or units may be performed through the bus. Functional aspects of the above example embodiments may be implemented in algorithms that execute on one or more processors. Furthermore, the components, elements or units represented by a block or processing steps may employ any number of related art techniques for electronics configuration, signal processing and/or control, data processing and the like.

While a few example embodiments have been described above, the scope of the disclosure is not limited thereto and various modifications and improvements made by those of ordinary skill in the art to concepts defined in the following claims should be understood to fall within the scope of the disclosure.

What is claimed is:

1. A first display apparatus, comprising:
a display;
a communicator configured to communicate with a second display apparatus; and
a processor configured to:
display an image on the display,
obtain a first ambient light value of a first ambient light of the first display apparatus,
receive a second ambient light value of a second ambient light of the second display apparatus and a second image-quality value of the second display apparatus through the communicator, and
adjust a first image-quality value of the displayed image based on the second image-quality value and the first ambient light value, by using a relationship between the second ambient light value of the second ambient light and the second image-quality value of the second display apparatus.

2. The first display apparatus according to claim 1, wherein the first ambient light value and/or the second ambient light value comprises at least one of an illumination value or a color temperature value of the first ambient light and/or the second ambient light.

3. The first display apparatus according to claim 1, wherein the processor is further configured to adjust the first image-quality value by changing at least one of brightness or a gamma curve of the displayed image.

4. The first display apparatus according to claim 1, wherein the processor is further configured to adjust the first image-quality value with reference to a table in which a plurality of preset image-quality values are tabulated corresponding to a plurality of ambient light values.

5. The first display apparatus according to claim 1, wherein the processor is further configured to adjust the first image-quality value by using a preset function or a preset algorithm based on a relationship between an ambient light value and an image-quality value.

6. The first display apparatus according to claim 1, wherein the processor is further configured to receive a user input value for the first ambient light from the second display apparatus, through the communicator.

7. The first display apparatus according to claim 1, wherein the processor is further configured to:
display a user interface (UI) comprising a plurality of selectable menu items about information of the first ambient light, and
receive, through the user interface, a user input value among the plurality of selectable menu items, and determine the first ambient light value of the first ambient light based on the user input value.

8. The first display apparatus according to claim 1, wherein the processor is further configured to receive the first ambient light value of the first ambient light from a server through the communicator.

9. The first display apparatus according to claim 1, wherein the processor is further configured to selectively perform adjustment of the first image-quality value based on whether a difference between the first ambient light value of the first ambient light and the received second ambient light value of the second ambient light is greater than a threshold apparatus.

10. The first display apparatus according to claim 1, wherein the processor is further configured to selectively perform adjustment of the first image-quality value based on whether a current time is in a preset timeslot.

11. The first display apparatus according to claim 1, further comprising a user input interface, wherein the processor is further configured to:
adjust a third image-quality value of a second image displayed on the display based on a user input received through the user input interface, and
transmit, to the second display apparatus through the communicator, the adjusted third image-quality value of the second image and a third ambient light value of the first ambient light of the first display apparatus detected while displaying the second image.

12. The first display apparatus according to claim 1, further comprising a sensor configured to detect the first ambient light value of the first ambient light of the first display apparatus.

13. A display system, comprising:
a first display apparatus; and
a second display apparatus placed in a different display environment from that of the first display apparatus,
the first display apparatus comprising:
a first display;
a first communicator configured to communicate with the second display apparatus;
a first sensor configured to detect a first ambient light of the first display apparatus;
a first user input interface; and
a first processor configured to:
display a first image on the first display,
adjust a first image-quality value of the displayed first image based on a user input received through the first user input interface, and
transmit the adjusted first image-quality value and a first ambient light value of the detected first ambient light to the second display apparatus through the first communicator, and
the second display apparatus comprising:
a second display;
a second communicator configured to communicate with the first display apparatus;
a second sensor configured to detect a second ambient light of the second display apparatus;
a second processor configured to:
receive the adjusted first image-quality value and the first ambient light value of the first display apparatus through the second communicator, and
adjust a second image-quality value of a second image displayed on the second display based on the first image-quality value and a second ambient light value of the second ambient light of the second display apparatus, by using a relationship between the first ambient light value of the first ambient light and the first image-quality value of the first display apparatus.

14. The display system according to claim 13, wherein the first ambient light value and/or the second ambient light value comprises at least one of an illumination value or a color temperature value of the first ambient light and/or the second ambient light.

15. The display system according to claim 13, wherein the first processor and/or the second processor is further configured to adjust the first image-quality value and/or the second image-quality value by changing at least one of brightness or a gamma curve of the first image or the second image.

16. The display system according to claim 13, wherein the first processor and/or the second processor is further configured to adjust the first image-quality value and/or the second image-quality value with reference to a table in which a plurality of preset image-quality values are tabulated corresponding to a plurality of ambient light values.

17. The display system according to claim 13, wherein the first processor and/or the second processor is further configured to adjust the first image-quality value and/or the second image-quality value by using a preset function or a preset algorithm based on a relationship between an ambient light value and an image-quality value.

18. A method of controlling a first display apparatus, the method comprising:
displaying an image on the first display apparatus;
obtaining a first ambient light value of a first ambient light of the first display apparatus;
receiving a second ambient light value of a second ambient light of a second display apparatus, and a second image-quality value of the second display apparatus; and
adjusting a first image-quality value of the image displayed on the first display apparatus based on the second image-quality value and the first ambient light value of the first ambient light of the first display apparatus, by using a relationship between the second ambient light value of the second ambient light and the second image-quality value of the second display apparatus.
